(19) United States
(12) Patent Application Publication
(10) Pub. No.: US 2023/0333917 A1
(43) Pub. Date: Oct. 19, 2023

(54) METHODS FOR PROVIDING COMPLIANCE INDICATORS FOR API SPECIFICATIONS

(71) Applicant: JPMORGAN CHASE BANK, N.A., New York, NY (US)

(72) Inventors: Jonathan LOWE, Glasgow (GB); Gordon Robert MACDONALD, Brooklyn, NY (US); Joanne Louise CROSS, Kilmarnock (GB); Rahul PATEL, Bangalore (IN); Gaurav KARKAL, Bangalore (IN); Hanuma SANAGAPATI, Bangaluru (IN); Jim SPEAKMAN, Glasgow (IN); Virginia SLADEWSKI, Middletown, DE (US); Ilya UTS, New York, NY (US)

(21) Appl. No.: 17/804,710

(22) Filed: May 31, 2022

(30) Foreign Application Priority Data
Apr. 16, 2022 (IN) 202211022565

(51) Int. Cl. G06F 9/54; G06F 8/60

(52) U.S. Cl. CPC G06F 9/541; G06F 8/60

(57) ABSTRACT

Systems and methods for providing compliance indicators for API specifications are disclosed. In accordance with aspects, a method may include receiving, at a deployment pipeline, an application programming interface (API) specification; parsing, by a validation engine, the API specification to determine an API service or protocol for which the API adheres to; parsing, by the validation engine, the API specification to determine a data schema included in the API specification; performing, by the validation engine, a search of a domain dictionary using information in the data schema as a search parameter; determining, by the validation engine and based on the search, a data model included in the domain dictionary, wherein the data model and the data schema correspond; and determining, by the validation engine, a compliance score of the data schema, wherein the compliance score is based on a comparison the data schema with the data model.

### RELATED APPLICATIONS

This application claims priority to, and the benefit of, Indian Provisional Patent Application No. 202211022565, filed Apr. 16, 2022, the disclosure of which is hereby incorporated, by reference, in its entirety.

### BACKGROUND

### 1. Field of the Invention

Aspects are generally related to systems and methods for providing compliance indicators for API specifications, in accordance with aspects.

### 2. Description of the Related Art

Application programming interfaces (APIs) act as contracts that allow data to be reliably exchanged between software services. The contract specifies a certain way to request data and what will be returned if the certain request is made. API documentation is a human-readable manual that specifies what data is available from an API and tells developers how to interact with an API. An API specification describes API protocol standards that standardize the data exchange process for all applications using a particular API protocol. APIs have become the preferred manner for data exchanges between networked software and are ubiquitous. With so many APIs being developed, however, good management of the available data that can be exchanged is essential to an organization's efficiency.

### SUMMARY

In some aspects, the techniques described herein relate to a method including: receiving, at a deployment pipeline, an application programming interface (API) specification; parsing, by a validation engine, the API specification to determine an API service or protocol for which the API adheres to; parsing, by the validation engine, the API specification to determine a data schema included in the API specification; performing, by the validation engine, a search of a domain dictionary using information in the data schema as a search parameter; determining, by the validation engine and based on the search, a data model included in the domain dictionary, wherein the data model and the data schema correspond; and determining, by the validation engine, a compliance score of the data schema, wherein the compliance score is based on a comparison the data schema with the data model.

In some aspects, the techniques described herein relate to a method, wherein the comparison includes a determination that an attribute of the data model is present as a corresponding attribute of the data schema.

In some aspects, the techniques described herein relate to a method, wherein the comparison includes a determination that a sub-property of the attribute of the data model is present as a sub-property of the corresponding attribute of the data schema.

In some aspects, the techniques described herein relate to a method, wherein the corresponding attribute of the data schema is given a percentage score, and wherein the percentage score reflects a relative similarity of the corresponding attribute of the data schema to the attribute of the data model.

In some aspects, the techniques described herein relate to a method, wherein the compliance score is based, in part, on the percentage score.

In some aspects, the techniques described herein relate to a method, wherein the compliance score is further based on a plurality of additional percentage scores, and wherein each of the plurality of additional percentage score reflects a respective similarity of one of a plurality of additional corresponding attributes of the data schema to one of a plurality of additional attributes of the data model.

In some aspects, the techniques described herein relate to a method, wherein the compliance score is less than a predefined threshold, and wherein, based on the compliance score being less than the predefined threshold, the deployment pipeline halts a deployment process of the API specification.

In some aspects, the techniques described herein relate to a method, wherein the compliance score is greater than a predefined threshold, and wherein, based on the compliance score being greater than the predefined threshold, the deployment pipeline deploys the API specification to a production environment.

In some aspects, the techniques described herein relate to a method, wherein the data model adheres to a standardized API specification format.

In some aspects, the techniques described herein relate to a method, wherein the API service or protocol is Representational State Transfer (RESTful).

### BRIEF DESCRIPTION OF THE DRAWINGS

FIG. 1 is a block diagram of a system for providing compliance indicators for API naming conventions, in accordance with aspects.

FIG. 2 is a logical flow for generating a compliance score for an API specification, in accordance with aspects.

FIG. 3 is a graphical representation of an integrated development environment, in accordance with aspects.

FIG. 4 is a logical flow for providing, in an integrated development environment, compliant data models for selection and inclusion as data schemas in an API specification, in accordance with aspects.

### DETAILED DESCRIPTION OF EMBODIMENTS

Aspects are generally related to systems and methods for providing compliance indicators for API specification, in accordance with aspects.

API's are used in countless ways by many organizations that publish share, provide, or otherwise depend on the movement of electronic data. Accordingly, data management in the context of API's is critical to the efficient use of API's, particularly in very large commercial, governmental, or other organizations. Key data management techniques in effective management of API data may include such concepts as keeping consistency in naming conventions, consistent data types for given fields (e.g., representing dates in a standard ISO format), grouping of attributes together into an “entity” and ensuring consistency across entities, etc. Having a defined naming convention and a consistent schema for all data that is processed across all of an organization's APIs can greatly improve efficiency in development efforts, deployment efforts, testing and compliance, etc. Such data consistency can also improve processing performance of underlying systems in terms of reads, writes, swaps, caches, and other memory management techniques, more efficient indexing of data, more accurate queries and query responses, etc.

An organization can configure an API to be a public API that anyone can access, a partner API that requires access rights from the publishing organization in order for access, or a private API that only or primarily interacts with other internal systems of the publishing organization. Public and partner APIs can be published via a public network, such as the internet, and via an external API gateway. Private APIs operate mainly behind an organization's firewalls on private networks. An organization's APIs can be based on any suitable API architecture. Exemplary API architectures and/or protocols include SOAP (Simple Object Access Protocol), XML-RPC, RESTful (Representational State Transfer), or the like.

As noted, above, an API acts as a kind of “contract” that allows data to be reliably exchanged between software services. The so-called contract is defined in the API specification. The specification specifies a certain way to request data and what will be returned if the certain request is made in the specified manner. APIs generally also include API documentation, which is a human-readable manual that specifies what data is available from an API and tells developers how to interact with the documented API.

Using the API documentation and the API specification, software developers can understand what data is available from a given API and how to request that data from the API. The API is said to be “published,” by the providing organization, because any party having the appropriate permissions can make a unilateral request for the data that the API provides. A software function that requests data from an API is sometimes referred to as an API “call.” The API documentation and specification define how an API call must be made. Some API calls must provide input data as a parameter of the call. Based on the particular API call and any input parameters as specified in the documentation and specification, an API will return the data that is associated (i.e., that is indicated in the documentation and/or specification) with the received call.

In accordance with aspects, an API specification can be provided to a deployment pipeline and the deployment pipeline can execute steps to determine to what degree the provided API specification complies with an organization's domain naming conventions and other data management techniques. In some aspects, a plugin for an integrated development environment (IDE) can be provided that allows an API specification developer to see and select attribute names from a domain dictionary while working in the IDE.

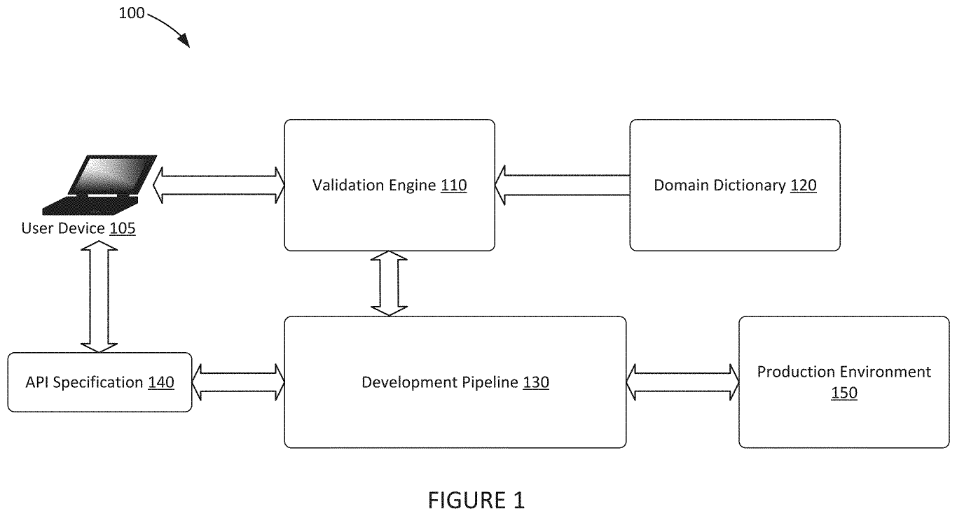

FIG. 1 is a block diagram of a system for providing compliance indicators for API naming conventions, in accordance with aspects. System 100 includes user device 105, validation engine 110, domain dictionary 120, development pipeline 130, and API specification 140, and production environment 150. System 100 may be included in the backend technology infrastructure of an organization. Such infrastructure can include servers, computers, software applications, computer network mediums, and computer networking hardware and software for providing electronic services based on computer software applications executing on requisite hardware. Exemplary hardware and software include webservers, application servers, database and data storage servers and appliances, communication servers such as email servers and SMS servers, network routers, switches and firewalls, custom-developed software applications including hardware to execute them on, etc. Each of validation engine 110, domain dictionary 120 and development pipeline 130, and components of production environment 150 can include software executing on hardware as describe, above.

User device 105 can be a smart phone, a tablet computer, a laptop computer, or any electronic device that is capable of storing and executing an IDE application. An IDE, as used herein, is software used for building computer applications using source code. An IDE can include a source code text editor, a build engine that can compile or interpret source code, a debugging feature for debugging source code, etc.

User device 105, validation engine 110, domain dictionary 120 and development pipeline 130, and components included in production environment 150 can each be communicatively coupled to each other via a communications network with appropriate hardware and software. For instance, components of system 100 can include a wired or wireless network interface card (NIC) that interfaces with the communications network and is configured with appropriate communication protocols for operative communication across the communications network. The communications network, itself, can include hardware (NICs, switches, routers, etc.) configured with appropriate protocols for facilitating intercommunication among network participants.

In accordance with aspects, API specification 140 defines an interface for a particular API protocol or service. API specification 140 is machine readable and can be human readable, as well. Exemplary machine-readable formats include JSON formatted specifications, XML formatted specifications, CSV formatted specifications, etc. API specification 140, upon inspection by a machine or a human, allows discovery of the capabilities of the relevant API service for which it was created or adopted. API specification 140 can be defined for an API that adheres to any suitable or desirable API service or protocol. For instance, an API specification may be developed for a RESTful API service, where the RESTful API service uses existing HTTP methodologies as defined by the RFC 2616 protocol. In accordance with aspects, API specification 140 can adhere to a standardized format, such as the OpenAPI Specification (OAS) as published by the OpenAPI Initiative (e.g., Version 3.1 of the Open API Specification, a copy of which is provided herewith, and the disclosure of which is hereby incorporated, by reference, in its entirety).

User device 105 can be configured for use with an IDE, and a developer may interact with user device 105 to create an API and to create API specification 140, which can act as the API specification for the developer's created API.

Domain dictionary 120 is a repository of data models that define how information shared by an organization's APIs should be structured. Data models defined by domain dictionary 120 may adhere to API specification standards, such as the OAS. Data structures in domain dictionary 120 may be hierarchical and may be implemented in a machine-readable format such as a JSON format. At a top level of a hierarchy of a data structure may be a data object. Each data object can be assigned elements that comprise the data object. Each element of each data object can, in turn, have a number of attributes that describe details of the element. Elements can include technical attributes, such as a data type (e.g., interger, string, boolean, etc.), and format. Elements may also have attributes that are descriptive of the element (such as a text description, a confidentiality level, on so on). Elements can have sub-properties. For instance a name element may specify a preferred name for the data element, and sub-properties of the element may define particular formatting restrictions, such as a minimum length, a maximum length, character capitalization requirements or restrictions on certain characters, etc.

Domain dictionary 120 can be one of many domain dictionaries that are stored in a central repository for data models that adhere to an organization's adopted API specification for a given API service/protocol. Domain dictionary 120 can include data models for several different API services/protocols. Any information that an organization provides via an API can have a data model included in domain dictionary 120. Domain dictionary 120 can be editable, such that if a data model for information is absent, it can be added to domain dictionary 120.

Validation engine 110 can be configured to work in conjunction with domain dictionary 120 and development pipeline 130 in order to assess API specification 140 and provide a compliance score for API specification 140. In accordance with aspects, a developer may develop an API-based project, including API specification 140 at user device 105, and may send the project to development pipeline 130. Development pipeline 130 may be configured to perform multiple compliance checks on developer projects before the projects are deployed to production environment 150. Development pipeline 130 can be configured to detect that the project is API-based and load the API specification 140 from a source code control repository where it is stored and accessed.

In accordance with aspects, metadata in API specification 140 can be parsed by validation engine 110 to determine a data dictionary which to assess API specification 140 against. For instance, if API specification 140 is a RESTful API specification and domain dictionary 120 is a dictionary that defines data models that comply with the organization's adopted standard for RESTful API specifications, then validation engine 110 may determine that all data references in API specification 140 must be validated against domain dictionary 120 in order to be eligible for use in production environment 150.

In accordance with aspects, validation engine 110 may parse API specification 140 and determine included data schemas. As used here, a data schema refers to data defined in a developed API specification, and a data model refers to an organization-approved data definition included in a domain dictionary. After determining a data schema defined in API specification 140 validation engine 110 can search domain dictionary 120 for a match to the determined data schema. A match can either be a full match or a partial match. A full match indicates that the determined data schema includes every attribute, or a high percentage of attributes, of the corresponding data model in domain dictionary 120. A partial match indicates that some attributes of the determined data schema are missing or different than those attributes are defined in the corresponding model in domain dictionary 120. After all determined data schemas for data elements in API specification 140 have been assessed against domain dictionary 120, validation engine 110 may return a compliance score with respect to API specification 140.

A compliance score may be based on an aggregate score of each determined data schema and may be returned as a percentage. That is, each element of a determined data schema may receive a score based on whether the element exists and, if so, how closely the element complies with its corresponding element from an appropriate domain dictionary. An element's score can be further based on any sub-properties of the element. In one aspect, a data schema may receive a percentage score that reflects the percentage of matches between all elements and sub-properties of the elements.

In accordance with aspects, if a data schema has 4 elements and two of the elements comply wholly with their corresponding elements in a domain dictionary, then each of those elements may score 100%. If a third element is noncompliant, that element may receive a 0% score. And if the fourth element has two sub-properties and one of the sub-properties is compliant, but the other sub-property isn't, that element may receive a 50% score. The scores may be aggregated to calculate an overall score for the data schema, and each score for each determined data schema in the API specification may be further aggregated to calculate an overall score for the API specification. Data models, elements, and sub-properties can also be assigned weights such that non-compliance with heavily weighted models, elements and sub-properties tend to lower an API specification's overall score, and vice versa.

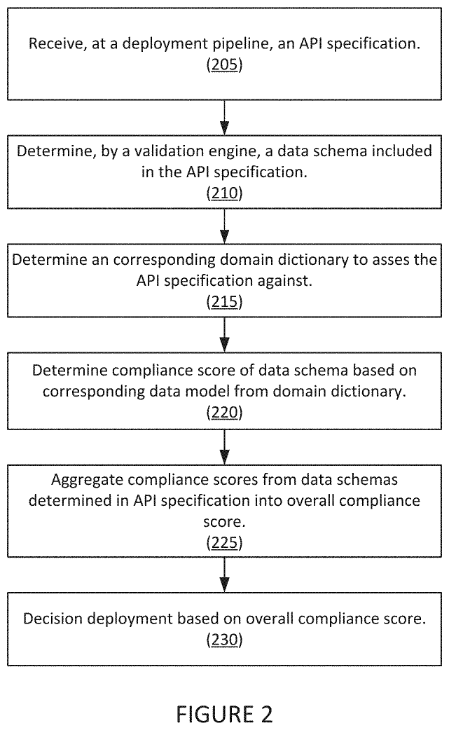

FIG. 2 is a logical flow for generating a compliance score for an API specification, in accordance with aspects. At step 205, a deployment pipeline can receive an API specification. The API specification can be received from a repository or other source code management system. The API can be a freshly created API specification for a corresponding API project. The developer of the API may prompt processing of the API specification through the development pipeline in order to allow the API specification and project to be deployed to a production environment.

At step 210 of FIG. 2, a validation engine of the deployment pipeline can be configured to parse the API specification and determine, based on the parsing, a data schema included in the API specification. An API data schema may provide information (i.e., metadata) about, and a structure of, data that is available to via an API call from the API for which the API specification was written.

An exemplary data schema that may be determined as included in the provided API specification may include

```
schemas:
  bill:
    properties:
      billCount:
        type: integer
        description: Enumerates the number of bills/invoices
        format: int32
        x-confidentiality: INTL
        x-directId: N
        x-pi: N
```

The validation engine may parse the API specification to determine the “schemas” field and then may parse within the schemas hierarchy to determine the “Bill” data schema and its attributes, as shown above.

Parsing of the API specification may further include identifying a type of API service and/or protocol that the specification is written for. For instance, the validation engine can parse headers or initial tags that indicate a service type, protocol or standards document to which the API specification adheres to. For instance, the validation engine can be configured to identify the following “Info Object” specified in the OAS version 3.1 to determine that the received API specification has been developed for a RESTful API project:

```
{
    “title”: “Sample Pet Store App”,
    “summary”: “A pet store manager.”,
    “description”: “This is a sample server for a pet store.”,
    “termsOfService”: “https://example.com/terms/”,
  “contact”: {
        “name”: “API Support”,
        “url”: “https://www.example.com/support”,
        “email”: “support@example.com”
    },
    “license”: {
      “name”: “Apache 2.0”,
      “url”: “https://www.apache.org/licenses/LICENSE-2.0.html”
    },
    “version”: “1.0.1”
}
```

Which may be parsed to read:

```
title: Sample Pet Store App
summary: A pet store manager.
description: This is a sample server for a pet store.
termsOfService: https://example.com/terms/
contact:
  name: API Support
  url: https://www.example.com/support
  email: support@example.com
license:
  name: LicenseProvide 2.0
  url: https://www.exemplarywebsite.org
```

The validation engine may look for fields in the machine-readable information (such as the JSON-formatted information, above) to determine the “title,” “summary,” “description,” “contact,” “license,” “version,” etc., fields, and a determination of such fields may indicate a RESTful API specification and may further indicate that the specification should adhere to the OAS standard.

At step 215 of FIG. 2, the validation engine may determine an appropriate domain dictionary to use for compliance assessment against the provided API specification. Determining the domain dictionary can be based on the parsing and determination of the API service/protocol as described, above.

At step 220 of FIG. 2, the validation engine can determine a data model from the domain dictionary that corresponds with the determined data schema from the API specification. Based on a comparison of the data schema and the corresponding data model, the validation engine can determine a compliance score of the data schema of the API specification. Compliance scoring is discussed in detail, above.

At step 225 of FIG. 2, the validation engine can aggregate the compliance score of the data schema with the scores of other data schemas detected from the API specification as described, above.

At step 230 of FIG. 2, the deployment pipeline can allow the API specification to proceed through the pipeline to a production environment, or can cancel deployment based on the API compliance score provided by the validation engine.

In accordance with aspects, an IDE can be configured to use a domain dictionary to display data objects having compliant data models defined in the domain dictionary, and to incorporate the complaint data model, as a data schema, into an API specification upon selection of the data object by a user of the IDE. Moreover, the IDE can be configured (e.g., when prompted by a user) to construct an API contract from portions of a data dictionary by placing text related to the data model into the API specification. That is, code for an API specification may be generated by the IDE based on the IDE's recognition of, and access to, a domain dictionary and an API specification standard (e.g., the OAS standard) from where the IDE can retrieve both the desired structure of the API specification it is creating (or helping to create) and the data models with which to populate the API specification with (as specification data schemas).

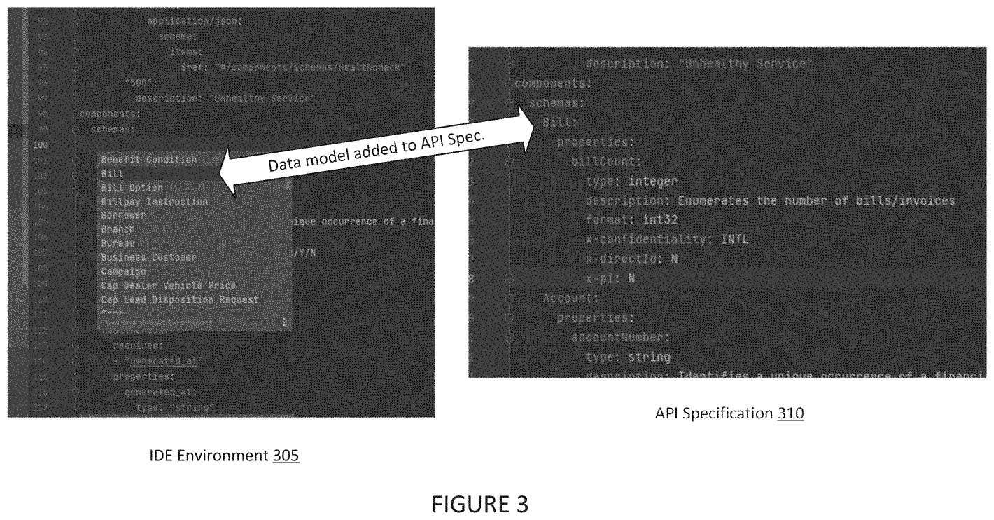

FIG. 3 is a graphical representation of an integrated development environment, in accordance with aspects. FIG. 3 includes IDE environment 305 and API specification 310. IDE environment 305 depicts an exemplary IDE at a time when a user of the IDE is attempting to add a data schema to an API specification being developed within the IDE. The IDE can be configured to retrieve a list of valid data models for the API specification service type or protocol, and display the list for selection in the IDE. The API specification service type or protocol can be determined by the IDE in the manner described above or can be indicated by the user of the IDE. The IDE may be configured to be in operative communication with a validation engine and/or a domain dictionary as described, above.

In accordance with aspects, the IDE can be configured with additional programmatic instructions, e.g., in the form of a “plugin” to the IDE. The additional instructions may configure the IDE to perform the steps described herein locally on the IDE platform. In other aspects, the plugin may configure the IDE to be in operative communication with a validation engine and/or domain dictionary, and may offload the steps described herein with respect to IDE integration to the validation engine/domain dictionary. In still other aspects, the instructions may configure the IDE to perform some of the steps locally, while offloading other of the steps to the validation engine/domain dictionary.

With continued reference to FIG. 3, API specification 310 shows an API specification in which the IDE has inserted the compliant data model selected by a user as a data schema in the API specification. The data model formatting and attributes can be taken directly from the domain dictionary and be included in the API specification as a data schema, such that a compliance score conducted on the included data schema will result in a 100% compliance score as described, above.

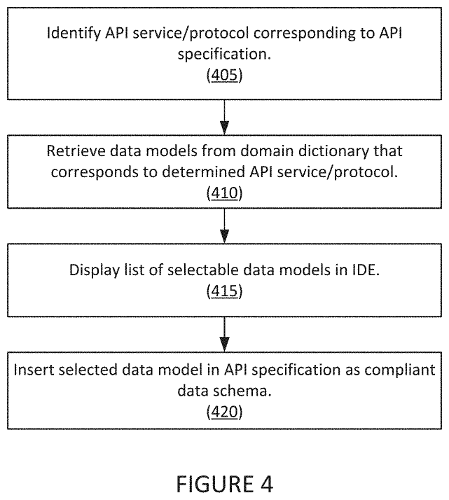

FIG. 4 is a logical flow for providing, in an integrated development environment, compliant data models for selection and inclusion as data schemas in an API specification, in accordance with aspects. The steps described below with reference to FIG. 4 may be performed locally in the IDE platform or may be offloaded to a validation engine and/or domain dictionary. Regardless of where the steps are performed, they may be performed in the manner described herein with respect to a validation engine and/or a domain dictionary.

At step 405, an IDE can determine an API service or protocol that corresponds with the API specification that is open/active in the IDE. At step 410, the IDE can retrieve, or receive, data models from the domain dictionary determined to correspond with the determined API service or protocol. At step 415, the IDE can render, as a list of selectable items, the compliant data models. At step 420, based on a selection from a user of the IDE, the IDE can insert the selected data model into an open API specification as a data schema of the API specification.

The various processing steps and/or data flows depicted in the figures and described in greater detail herein may be accomplished using some or all of the system components also described herein. In some implementations, the described logical steps may be performed in different sequences and various steps may be omitted. Additional steps may be performed along with some or all of the steps shown in the depicted logical flow diagrams. Some steps may be performed simultaneously. Some or all of the steps from one logical flow may be performed along with the steps of another logical flow. Accordingly, the logical flows illustrated in the figures and described in greater detail herein are meant to be exemplary and, as such, should not be viewed as limiting. These logical flows may be implemented in the form of executable instructions stored on a machine-readable storage medium and/or in the form of electronic circuitry.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, aspects of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at a deployment pipeline, an application programming interface (API) specification;
parsing, by a validation engine, the API specification to determine an API service or protocol for which the API adheres to;
parsing, by the validation engine, the API specification to determine a data schema included in the API specification;
performing, by the validation engine, a search of a domain dictionary using information in the data schema as a search parameter;
determining, by the validation engine and based on the search, a data model included in the domain dictionary, wherein the data model and the data schema correspond; and
determining, by the validation engine, a compliance score of the data schema, wherein the compliance score is based on a comparison the data schema with the data model.

2. The method of claim 1, wherein the comparison includes a determination that an attribute of the data model is present as a corresponding attribute of the data schema.

3. The method of claim 2, wherein the comparison includes a determination that a sub-property of the attribute of the data model is present as a sub-property of the corresponding attribute of the data schema.

4. The method of claim 3, wherein the corresponding attribute of the data schema is given a percentage score, and wherein the percentage score reflects a relative similarity of the corresponding attribute of the data schema to the attribute of the data model.

5. The method of claim 4, wherein the compliance score is based, in part, on the percentage score.

6. The method of claim 5, wherein the compliance score is further based on a plurality of additional percentage scores, and wherein each of the plurality of additional percentage score reflects a respective similarity of one of a plurality of additional corresponding attributes of the data schema to one of a plurality of additional attributes of the data model.

7. The method of claim 6, wherein the compliance score is less than a predefined threshold, and wherein, based on the compliance score being less than the predefined threshold, the deployment pipeline halts a deployment process of the API specification.

8. The method of claim 6, wherein the compliance score is greater than a predefined threshold, and wherein, based on the compliance score being greater than the predefined threshold, the deployment pipeline deploys the API specification to a production environment.

9. The method of claim 1, wherein the data model adheres to a standardized API specification format.

10. The method of claim 1, wherein the API service or protocol is Representational State Transfer (RESTful).
